(19) United States
(12) Patent Application Publication
(10) Pub. No.: US 2012/0204201 A1
(43) Pub. Date: Aug. 9, 2012

(54) PERSONALIZED BEST CHANNEL SELECTION DEVICE AND METHOD

(75) Inventors: Timothy M. Cassidy, Plymouth, MN (US); Nigel Waites, Lakeville, MN (US)

(73) Assignee: BBY SOLUTIONS, INC., Richfield, MN (US)

(21) Appl. No.: 13/179,677

(22) Filed: Jul. 11, 2011

Related U.S. Application Data
(60) Provisional application No. 61/439,182, filed on Feb. 3, 2011.

(51) Int. Cl. H04N 21/258; H04N 21/442

(52) U.S. Cl. 725/10; 725/14

(57) ABSTRACT

A device and method is presented that analyzes a user's television viewing behavior and, in response to a single action by the user, immediately presents the next highest ranked video content for that user on the television display. One embodiment provides a single button on a remote control that initiates this method. The ranked video content is based upon user identification and monitoring past user interaction with the television. Programming viewed by a user is compared against currently available programming to create a ranked list of recommended programming for the user. The preferred embodiment monitors and suggests programming that is provided on multichannel video programming such as over-the-air, cable, and satellite television programming, as well as material that is available for streaming over the Internet.

### CROSS REFERENCE TO RELATED APPLICATION

This application claims the benefit of U.S. Provisional Application No. 61/439,182, filed Feb. 3, 2011, which is hereby incorporated by reference.

### FIELD OF THE INVENTION

The present invention relates to the field of video content ranking based on user preferences. More particularly, the invention relates to a device and method that analyzes a particular user's past television viewing behavior and, in response to a single action by the user, presents the next highest ranked best video content for that user on a television display.

### SUMMARY

One embodiment of the present invention provides a single personalized channel button on a television remote. This embodiment identifies a user, and then monitors the user's interaction with a television. The channels and particular programming viewed by the user are recorded in a database, along with the time of day and the day of the week. The embodiment further monitors the user's usage of network applications through the television, allowing the database to contain information on most or all of the user video preferences and not just the user's viewing of standard television programming. Upon the pressing of the personalized channel button or otherwise submitting the personalized programming command to the system, the embodiment analyzes the available content in light of the past user behavior recorded in the database to select the best material currently available for the user. The television settings are then automatically changed so as to present that material to the user.

If the personalized channel button is pressed again, the second best available video material is presented to the user, and so on. The embodiment is aware of current programming available on multichannel video programming such as over-the-air, cable, and satellite television programming, as well as material available over network applications such as Hulu, NetFlix, CinemaNow, etc. To present a sufficiently quick user experience, the embodiment may present a summary page when network application programming is presented, allowing the user to identify the selected content without requiring the application to load and present the material through the television interface.

The embodiment can be integrated into a standard television or a set-top box. It is preferred that the embodiment be able to monitor a majority of the material selected by the user to view on the television. To accomplish this, one embodiment is implemented on a device that controls both multichannel video programming and Internet application content.

### BRIEF DESCRIPTION OF THE DRAWINGS

FIG. 1 is a perspective view of one embodiment of the present invention combining a remote control, a set-top box, and a television.

FIG. 2 is a table of representative data that is stored in a database in another embodiment.

FIG. 3 is a flow chart of one method that can be used to identify programming currently being viewed by a user.

FIG. 4 is a flow chart of a method used to record identified programming in a database.

FIG. 5a is a schematic view of a system capable of a first technique for identifying a user.

FIG. 5b is a schematic view of a system capable of a second technique for identifying a user.

FIG. 5c is a schematic view of a system capable of a third technique for identifying a user.

FIG. 5d is a schematic view of a system capable of a fourth technique for identifying a user.

FIG. 5e is a schematic view of a system capable of a fifth technique for identifying a user.

FIG. 5f is a schematic view of a system capable of a sixth technique for identifying a user.

FIG. 5g is a schematic view of a system capable of a seventh technique for identifying a user.

FIG. 6 is a flow chart of one method that can be used to implement the automatic switching of a television to the next highest rated programming option upon request by the user.

FIG. 7 is a schematic diagram showing the inputs that can be provided to a recommendation engine to provide a sorted list of recommended programming for a user.

FIG. 8 is a schematic diagram of an embodiment of the present invention showing the primary internal components.

### DETAILED DESCRIPTION OF THE INVENTION

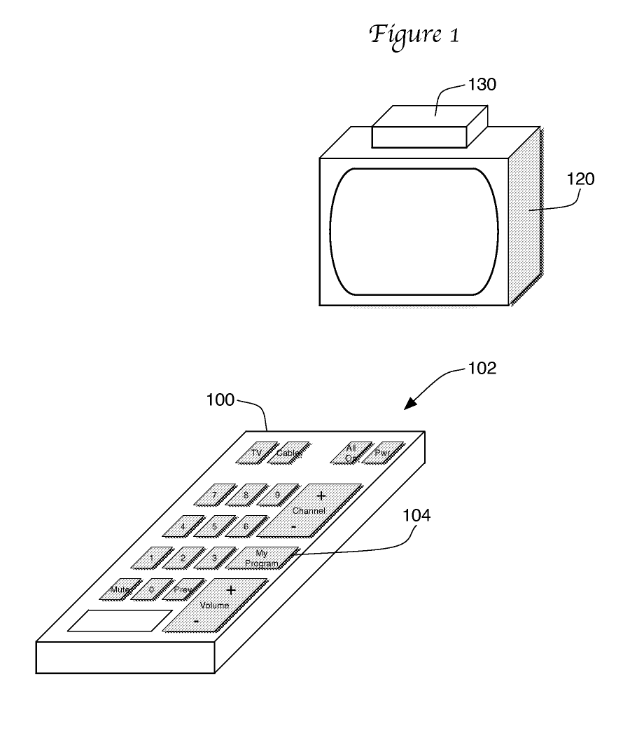

FIG. 1 shows a remote control 100 utilizing one embodiment of the present invention. The remote control has a variety of buttons 102, including power buttons, numerical buttons, volume buttons, and channel up and down buttons. These buttons 102 interact with a television or other display device 120 that shows video and audio content to the user. The remote control 100 may interact exclusively with the television 120, or may also control a set-top box 130 or any other device that provides content to the display 120. The set-top box 130 may take the form of a cable or satellite box provided by a cable company or satellite television provider to provide access to multi-channel video programming. In this context, multi-channel video programming is a service that provides access to multiple channels of video entertainment for a fee to subscribers, where each channel provides the same programming to all customers receiving that channel. Multi-channel video programming providers will also frequently provide on-demand or pay-per-view programming, where users can individually select a program for viewing, and then control the playback of video content using the remote 100. The set-top box 130 may also take the form of a digital video recorder (or “DVR”), a DVD or Blu-ray disc player, a personal computer that accesses locally stored video content, or a networked video streaming device that is able to stream video content on demand over the Internet.

In FIG. 1, a single set-top box 130 is shown providing video signals to the television 120. In many households, numerous set-top boxes 130 are connected to the television 120. For example, a household that receives multi-channel video programming through a cable box may also have a Blu-ray player for playing Blu-ray and DVD discs, a Roku device (from Roku, Inc. of Saratoga, Calif.) to stream video content over the Internet, a PS3 dedicated gaming system (from Sony Corp. of Tokyo Japan), a TiVo DVR device (from TiVo Inc. of Alviso, Calif.) to record and playback video content received from the cable box, and a media computer to play video files stored on hard disks connected to the media player. The television 120 in this scenario may only display programming provided by these other set-top devices 130. Alternatively, the internal ATSC tuner within the television 120 might also provide over-the-air content that is not available through the other sources.

As the number of video sources escalates, consumer electronic manufacturers have brought forth offerings that combine multiple sources into a single device. For instance, DVR devices now frequently include the ability to receive and decode multi-channel video programming provided by satellite or cable providers, record those programs for later viewing, and stream video from online sources over the Internet. In fact, smart or connected televisions frequently combine a ATSC and QAM tuners, multichannel video service decoding capabilities (such as through a CableCARD or AllVid compatibility), DVR recording abilities, Internet streaming, and a Blu-ray disc player into a single device.

One advantage of combining these disparate video sources into a single device is the ability to track the viewing habits of users across a variety of sources. In the embodiment shown in FIG. 1, the set-top box 130 should be considered an integrated device that provides a plurality of video sources to the user, and then presents the selected video content to the television or other display device 120. Because most or all of the video sources available to the user are provided by this single device 130, the set-top box 130 is well positioned to monitor the viewing habits of its users. Note that the television 120 itself could function as the integrated device instead of the set-top box 130. In fact, connected or smart televisions 120 are rapidly replacing numerous set-top boxes 130 with a single device 120 that not only displays video content but also provides content for the user directly from a variety of sources. In the description below, the remote 100 is described as controlling the set-top box 130, with the television 120 effectively operating as a passive video monitor. This invention is equally applicable to an integrated television 120, where the remote control directly controls the television 120 instead of the set-top box 130. In fact, the invention would also be effective in situations where the television 120 and one or more set-top boxes 130 separately provide video programming to the user, as long as a single device is able to identify the various programs being displayed and directly request video content from the other devices.

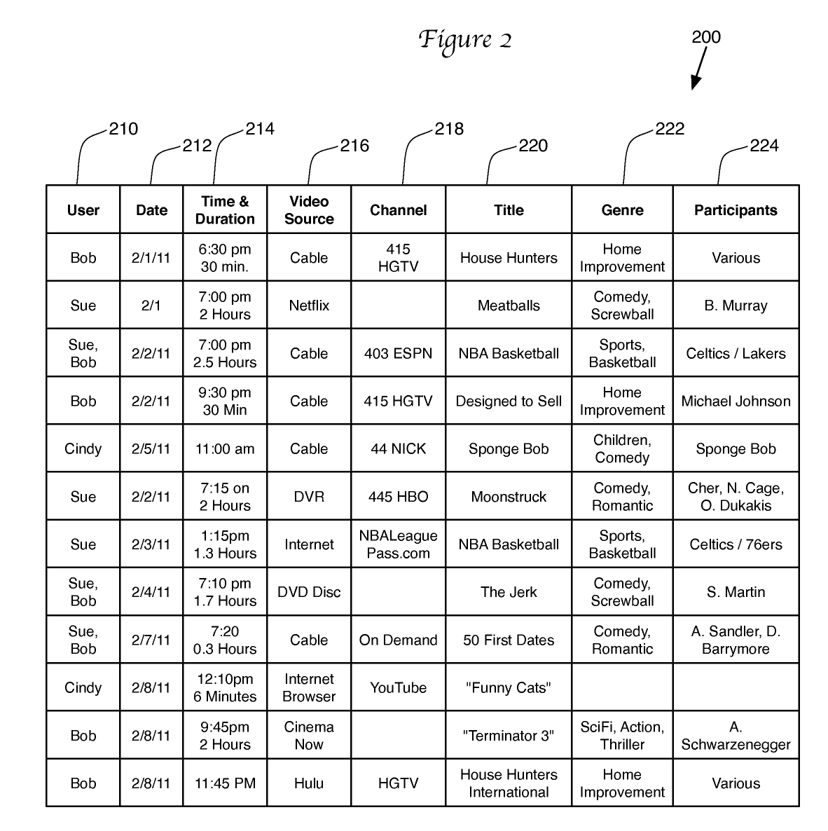

In one embodiment, the set-top box 130 monitors and identifies the video content that it displays over the television 120, and tracks the identification of such content in a database. This database can be locally stored within the set-top box 130, or can be stored at a remote server that is accessed by the set-top box 130. FIG. 2 shows an example of the data that might be tracked in one embodiment of such a database 200. In particular, the database 200 tracks the user or users 210 who are controlling the set-top box 130, the date 212 the program was viewed, the time and duration 214 of the viewing, the video source 216, the channel 218, the particular program viewed 220, the genre for the program 222, and the primary actors or participants 224 in the program (such as actors in a movie or sports teams in a sporting event).

As can be seen from the database 200, the set-top box 130 can track multiple video sources 216 in the database 200. In the exemplary data showed in FIG. 2, the users of the device accessed channels provided by a cable provider, an on-demand movie provided through the cable service, a program recorded by the DVR, a Netflix streamed movie, a YouTube video, a CinemaNow rental movie, a DVD movie, and a television show accessed from a Hulu Plus account.

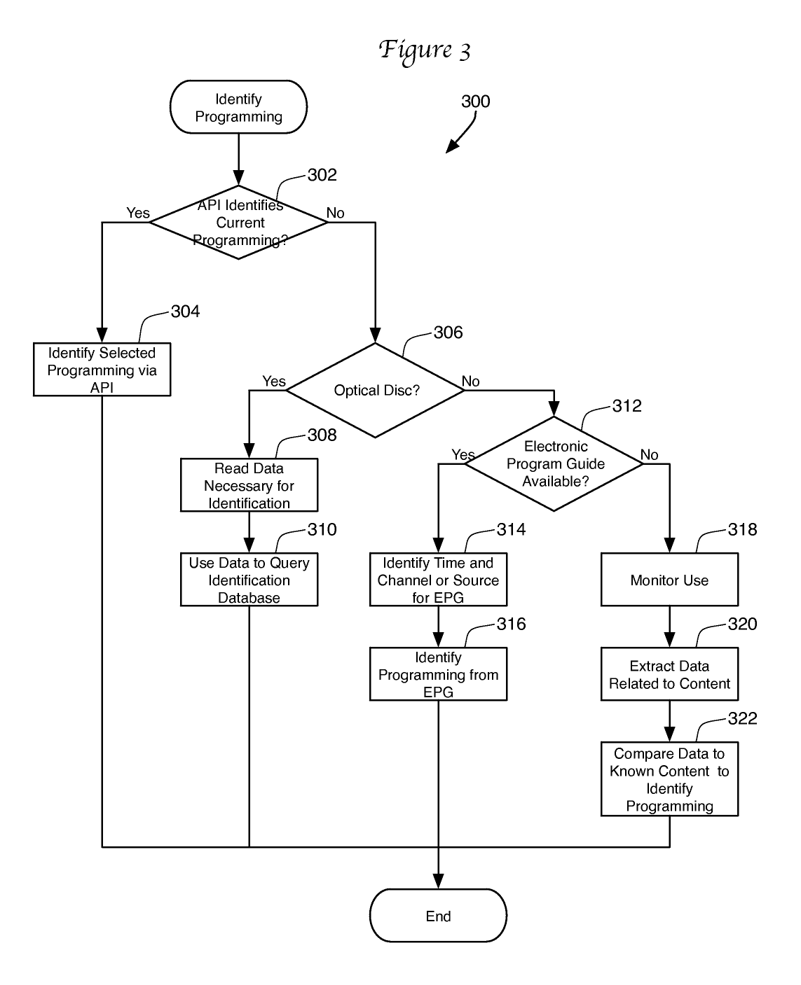

Each of these sources will involve different issues as the set-top box 130 attempts to identify the content currently being viewed, as is shown in the flow chart 300 of FIG. 3. In most cases, the identification can be provided to the set-top box 130 through an API (or application programming interface) provided by the video source provider. For instance, a multi-channel video programming source such as cable or satellite television service will be made available to the set-top box through hardware-based interfaces such as a CableCARD. Information about currently viewed video content can be obtained through the API that allows interaction with the CableCARD. Similarly, APIs that are provided by the application programming or “app” that connects to Internet video sources can also provide the identification of the currently viewed content. When a user elects to view particular content through an Internet video streaming service, such activity will take place through the app provided for that service. The set-top box 130 providing this programming can use the APIs for that app to identify the video selected by the user. If such an API is available for the source, as determined at step 302, the API is used at step 304 to perform the identification. This identification information can also be stored with the video whenever a video program is stored by the DVR functionality, allowing instant identification during the later playback of those programs.

In other cases, identification is slightly more complicated. For instance, DVD or Blu-ray discs will played by users inserting the disc into a slot or tray provided by the set-top box 130 or television 120. While some information about the disc content is provided on the disc itself, a more complete identification usually requires the use of an identification service. One such services is the VideoID database provided by Gracenote, Inc. (of Emeryville, Calif.), which provides consumer electronic devices with video metadata for the DVD and Blu-ray discs that are played on that device. Consequently, if step 306 determines that the source is an optical disc, step 308 reads the information about the disc's content, which is then submitted to the identification service at step 310. Alternatively, electronic programming guide (or EPG) services provided by programming service may allow the box 130 to identify the programming found on any selected channel at a particular time. If an EPG is available (step 312), the current time and channel (or other source identifier that is needed by the EPG) is identified at step 314. This information is then used to query the programming guide at step 316 in order to identify the currently viewed programming.

Where no API, EPG, or third party identification service is available, two options remain. The first is to simply skip identification for this step. This means that this video programming would not be stored in the database 200, or that very little information about that programming will be stored. Alternatively, the set-top box 130 can do its best to analyze the programming by monitoring user interaction with the source or by directly monitoring the audio/video material that is being played over the television (step 318). With such monitoring, the box 130 should be able to extract some data related to the content being viewed by the user (step 320). For instance, if user interaction is being monitored during use of a web browser built into the set-top box 130, the set-top box 130 could identify a URL being viewed by the user (such as the URL for a particular YouTube video). The URL should be sufficient to identify the video, particularly if an outside database (as shown in step 322) is utilized to identify particular video content by URL. As an alternative to video identification through the URL, the set-top box might also scrape the relevant data from the received HTML. With knowledge of how a video website presents information in the websites, scraping this data would allow the set-top box 130 to identify the title of video, the submitter of the video, the duration, and related data.

Alternatively, the monitoring step 318 could monitor the actual audio/video stream being presented to the user and extract data directly from that content. This would be the only technique available if the set-top box 130 or television 120 was attempting to identify video received through a video input port from an outside source. In one technique, the video stream presented on television 120 could be monitored and analyzed for image edges in the video stream, and these edges could be compared against a library of edges in order to recognize and identify the video stream. Algorithms for video recognition using edge detection are known in the prior art, such as the algorithm described in U.S. Published Patent Application No. 2008/0247663. Edges detected in the video stream presented over television 120 must then be compared with a database of known videos in step 322. This database is preferably centrally located, so that it can be accessed and utilized by a variety of set-top boxes 130 over a wide area network. The central database compares the edge data from the current video stream against its library of previously identified videos in order to identify the currently viewed television programming. The library of previously identified video could be a comprehensive library of as many video programs as possible. Alternatively, the database could focus on currently available programming. In this case, the central database would monitor all common channels in multi-channel programming in order to create a constantly updated database of image edge data. The edge detection conducted at the set-top box 130 would then be compared first to the data extracted from programming that is currently being broadcasted to order to simplify video recognition.

In addition to the use of edge detection to recognize video programming, it is also possible at step 320 to extract the audio portion of the television programming, and to then compare this audio portion to known audio signals in step 322. In audio recognition, a portion of the audio being presented over the television 120 is analyzed in order to convert the audio into a digital signature. A variety of algorithms exist for creating this digital signature in the prior art, such as that described in U.S. Pat. No. 7,562,012. The audio digital signal that is collected from the currently displayed television programming in step 320 is then compared against a database of reference signatures at step 322 in order to identify the television programming.

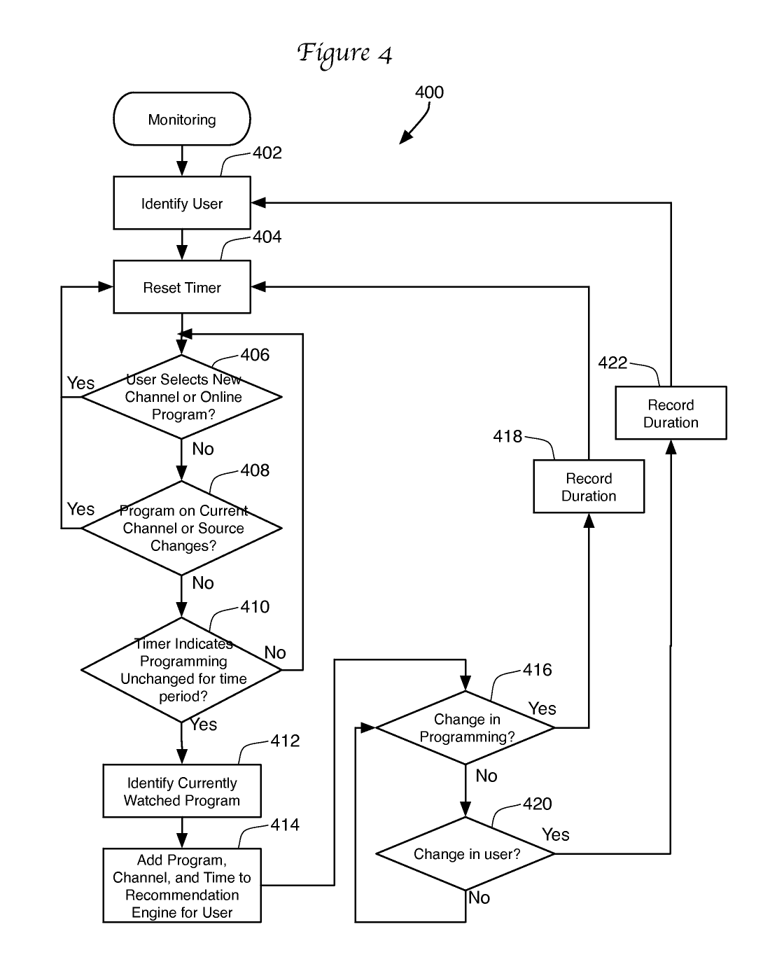

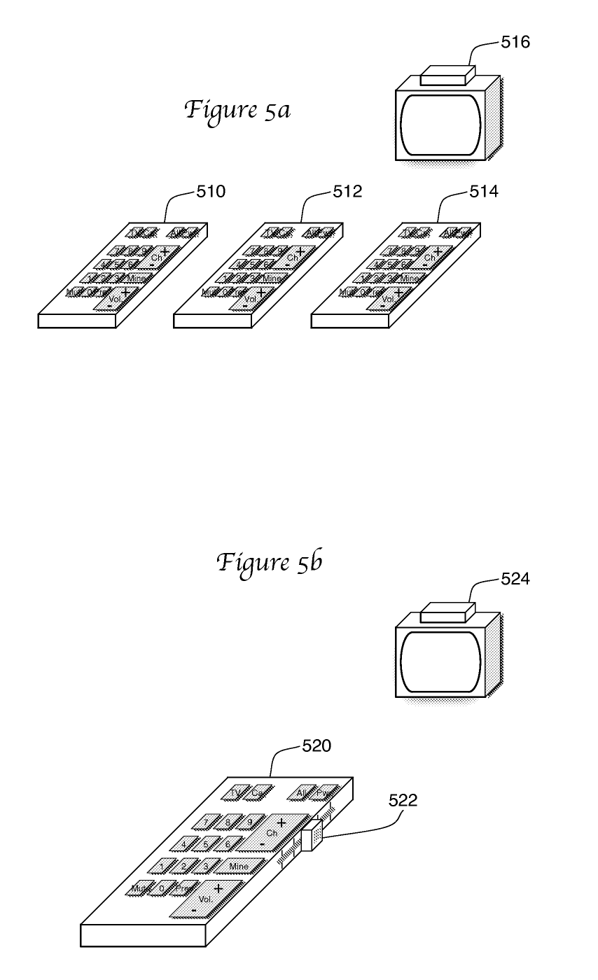

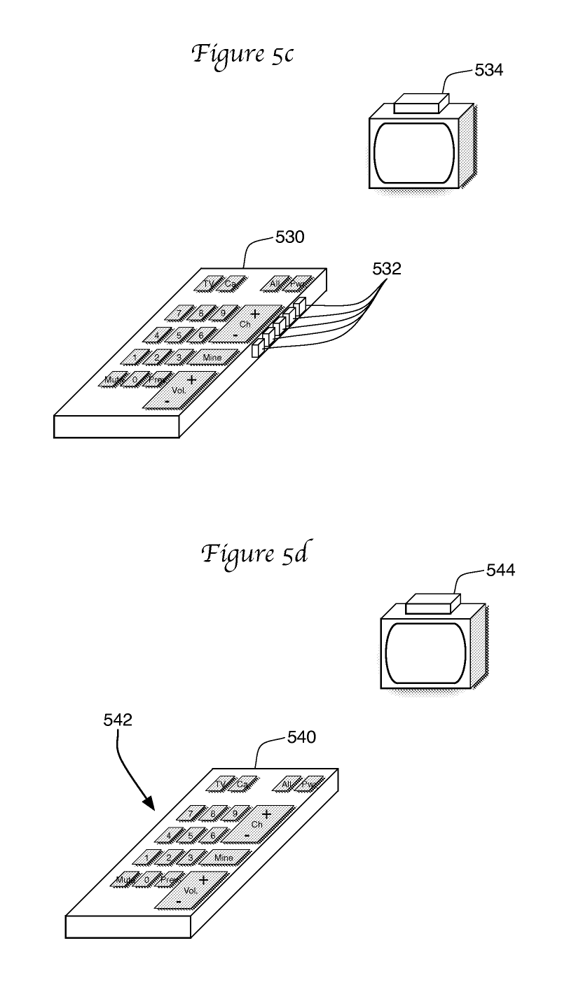

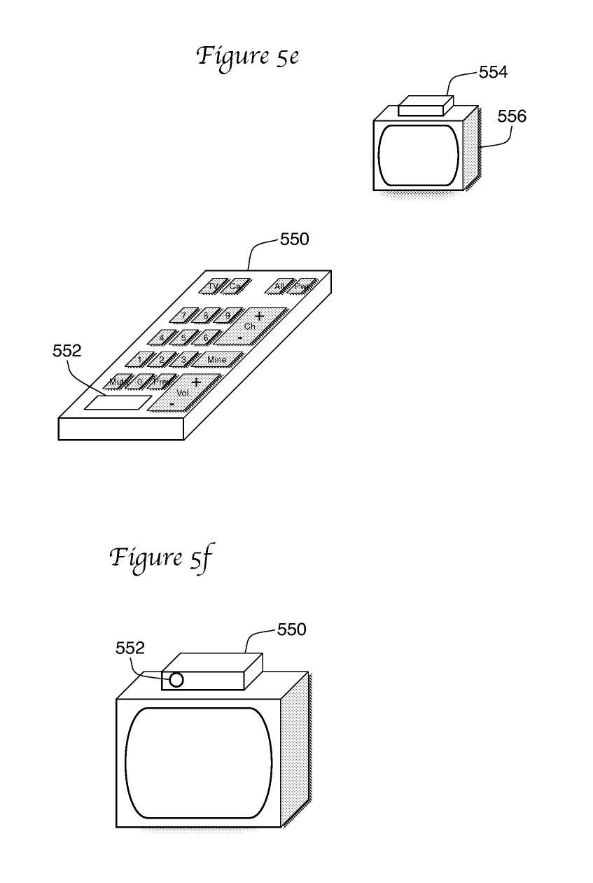

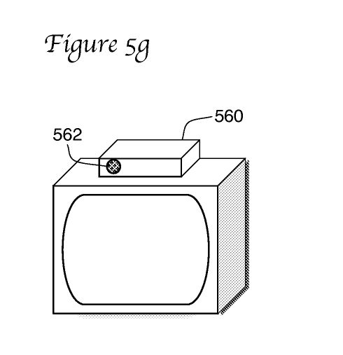

When identifying programs for the database 200, it is important to identify both when a program changes on a video source, and when the user that is viewing the program changes. In addition, in order for the database to accurately reflect user choices, it is important to ignore those programming choices that were quickly reviewed and rejected by a user. The flowchart 400 of FIG. 4 shows one possible method for making these distinctions. The flowchart starts at step 402, where one or more users are identified. The process for identifying a user is described in more detail below in connection with FIGS. 5a-5g.

Once a user is identified at 402, an internal timer is started or reset in step 404. The timer is used to ensure that a user has spent sufficient time on a single video program so as to indicate that the user has chosen to view the program. The timer is reset whenever the user changes the channel in a multi-channel video service, or otherwise alters the content that they are viewing on television 120, as shown in step 406. In addition, the method 400 is aware when programming on a single channel or source changes. When such changes occur, step 408 causes the method to return to step 404 and reset the timer.

If the timer indicates that a video program has not been watched for a significantly long period to be recorded in the database at step 410, the process returns to step 406 to monitor for changes in programming. If the timer indicates that the program has been watched by the user for a sufficient period, step 412 proceeds to identify the program. This occurs using the process 300 shown in FIG. 3. This identification should include not only the title of the programming, but also the genre and actors or participants as would be required to complete an entry in the database 200. The database entry is made at step 414.

After the entry is made, step 416 monitors the video source and the user selections to see if there has been a change in the video programming. If so, the total duration of time that the user had watched the previous programming is recorded at step 418, and the time is reset at step 404.

Step 420 also monitors for a change in the user that is watching the television 120. If a change in the user is noted, the duration that the previous user watched the program is recorded at step 422, and the current user or users are then identified at step 402. If no change in user is noted, the process 400 loops back to step 416 to await a change in users or programming. Note that an additional step could be added between step 406 and 410 that included a change in users step, much like step 420. If this additional step noted a change in users, the method would return to step 402 and identify the new users.

As shown in FIG. 2, one embodiment of the present invention identifies the user in the database 200 along with the video program currently being viewed. In one schema, a single user or household is associated with each set-top box 130, and the box 130 does not attempt to distinguish between users. In the preferred embodiment, however, the set-top box 130 is able to distinguish between multiple users. In order to accomplish this distinction, the set-top box 130 implements a user identification mechanism. FIGS. 5a-5g show six different mechanisms that can be used to identify a user. In FIG. 5a, multiple remotes 510, 512, and 514 are each capable of controlling a set-top box 516. Each remote 510-514 is pre-programmed with a different internal identification code. The identification code can be pre-programmed at the factory, so that every remote that is manufactured has a separate identifier stored in internal memory. Alternatively, the remotes 510-514 can be assigned a code number by the user, which would require only that the identifiers be unique within a household. The remotes 510-514 transmit this code to the set-top box 516 during use. Information about each of the known users of the set-top box 516 is stored in the box 516 in non-transitory memory. This user information is correlated with the remote control identifiers, such that each identifier (and hence each remote) is associated with a particular user. Each user then is assigned a single remote control 510-514 to use with the set-top box 516. During such use, the identifier in the remote 510-514 is transmitted to the set-top box 516, allowing the box 516 to identify the user currently controlling the box 516. This user information is then stored in the database 200 along with information about the video programming watched by that user. The identifiers can be transmitted by the remotes 510-514 at a variety of times. In one embodiment, the identifier is transmitted when the set-top box 130 is powered on. In other embodiments, the identifier is transmitted with every signal sent from the remote 510-514. In still further embodiments, the remotes 510-514 are programmed to periodically transmit their identifiers. These periodic transmissions could be based upon a time interval (every fifteen minutes) or a usage interval (every fourth button press), or some combination (the first button press after fifteen minutes has passed since the last transmission).

In FIG. 5b, a single remote 520 having a physical switch 522 is used to control a set-top box 524. The physical switch 522 is used to identify separate users. The switch 522 is designed to have multiple positions, allowing each position to be assigned to a different user of the box 524. As with the embodiment shown in FIG. 5a, the identity of the user can be transmitted via the remote 520 to the set-top box 524. In this case, the position of the switch 522 is transmitted to the box 524 in the same way the identifiers in the remotes 510-514 were transmitted. One weakness with using the multiple position switch 522 to identify users is that it relies upon users to reposition the switch 522 every time a new user begins to use the set-top box 524. This could be encouraged by tying use of the remote 520 to the verification of the position of switch 522. For instance, the remote could require reactivation after a period of inactivity. Reactivation may require physically pressing the position switch 522 inward, therefore requiring contact with the user selection switch 522.

In FIG. 5c, the multi-position switch 522 of FIG. 5b is replaced with multiple user buttons 532 on the remote 530. Each user is assigned a unique button 532. To identify themselves as the user of the set-top box 534, a user simply presses their assigned user button 532 on the remote 530. To encourage self-identification, the remote 530 could implement the same reactivation scheme as described above in connection with remote 520, with reactivation of the remote requiring the user to select one of the user identification buttons 532. Although the remote 530 in FIG. 5c is shown with dedicated physical user buttons 532, this embodiment could utilize virtual buttons on a touchscreen or soft buttons that are re-labeled on a nearby LCD or other screen during use of the remote 530. The benefit of a touchscreen or soft button is that user names could be associated with each button, therefore easing the task of a user self-identification.

In FIG. 5d, the remote control 540 has no buttons dedicated to user identification. Instead, the remote 540 has standard number buttons 542 that allow the user to identify themselves by inputting a passcode or personal identification number (or “PIN”). Of course, the buttons 542 on the remote could include letter buttons, allowing a more complicated password to be used for user identification. As above, new user identification could be encouraged through reactivation techniques. In one embodiment, the television or set-top box 544 could remain effectively inoperative after power up until a PIN is entered into the remote 542.

The remote 550 show in FIG. 5e contains a biometric identification area 552 built into the remote 550. In this case, the biometric area is a finger print pad 552 upon which a user places a finger for identification. Other types of unambiguous biometric identification could also be used. For example, a camera located on the remote 550 could be used for iris identification although the current cost of the necessary equipment makes this implementation impractical at the present time.

In the embodiment shown in FIG. 5f, user identification does not require active participation by the user. Instead, a camera 552 on the set-top box 550 takes images of the users of the box 550 and applies facial recognition techniques to identify the current users. In this case, multiple users can be identified simultaneously. These multiple users could together be identified as the current user in the database 200, such that the currently watched program is associated with all of the identified users. Alternatively, a single user from the group of identified users could be associated with the current program in the database 200. To select a single user, the set-top box 550 could apply a ranking algorithm, such as the youngest or oldest viewer, or a custom algorithm established by the users of the system.

Finally, FIG. 5g uses a microphone 562 in the set-top box 560 to identify users through voice or speaker recognition. The system in the set-top box could request or require that users identify themselves vocally, such as by stating their names. The box 560 could use voice recognition and then compare the spoken name to the pre-defined list of potential users of the box 560. When a match is made, a user is identified. By simply comparing the spoken names to the pre-defined list, it would be possible for any user present to simply speak the names of all users present. In other systems, the box 560 could use known speaker recognition algorithms to verify the identity of each speaker. This would require each user to identify his or her self, and the box 560 would verify the voice against a registered voice for the purpose of speaker identification. Once again, multiple users could be identified and tracked in the database 200.

The ability to track users of a television system can be leveraged for customized program recommendations. In one embodiment, these recommendations are provided through a specialized “My Channel” or “My Program” button on the remote control, such as button 104 on the remote 100 shown in FIG. 1. This button 104 immediately changes the programming selected by the set-top box 130 to a program that is specifically recommended for the current user. Prior art video recommendation engines, such as that embodied in the TiVo DVR systems, typically generate a list of recommended programs based on the viewing habits of an entire household. The list may include the programming currently available on a multi-channel video service, or future programs that may be recorded by the TiVo system. The user must then review the list, select an item, and the device will then either change to that program or schedule the program for recording. The “My Program” button 104 instead instantly changes the program currently being viewed to the most highly recommended program that is currently available for that user. If the user does not want to watch this programming, the My Program button 104 can be pressed again, and the second highest rated available program for that user will be selected.

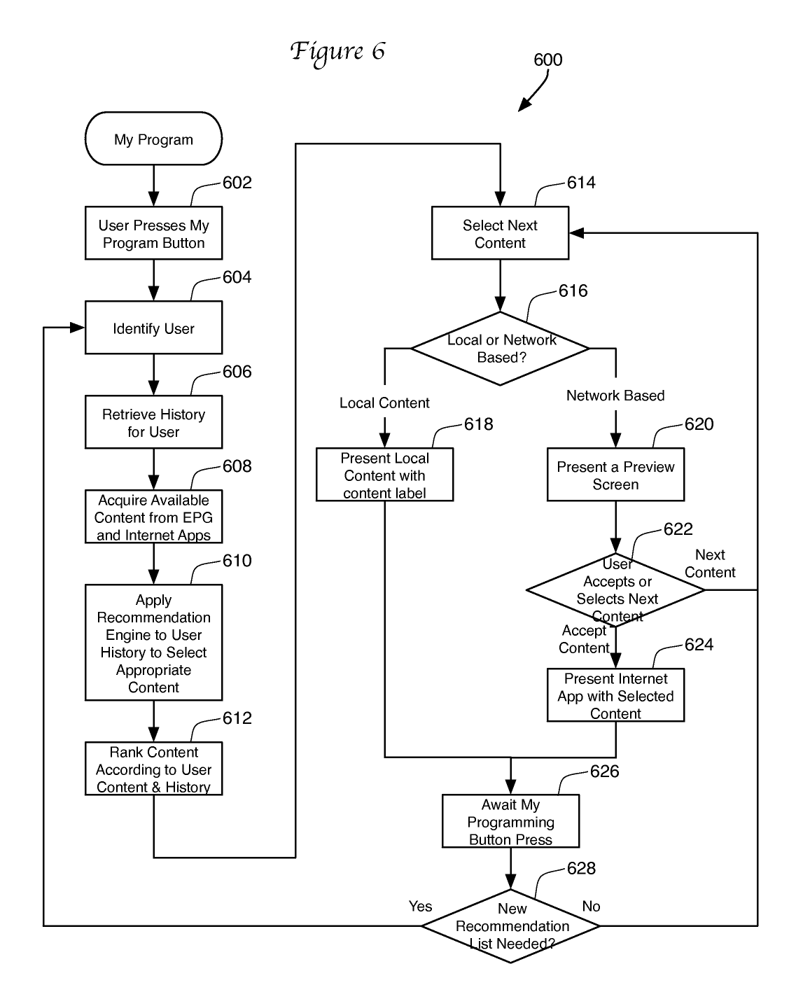

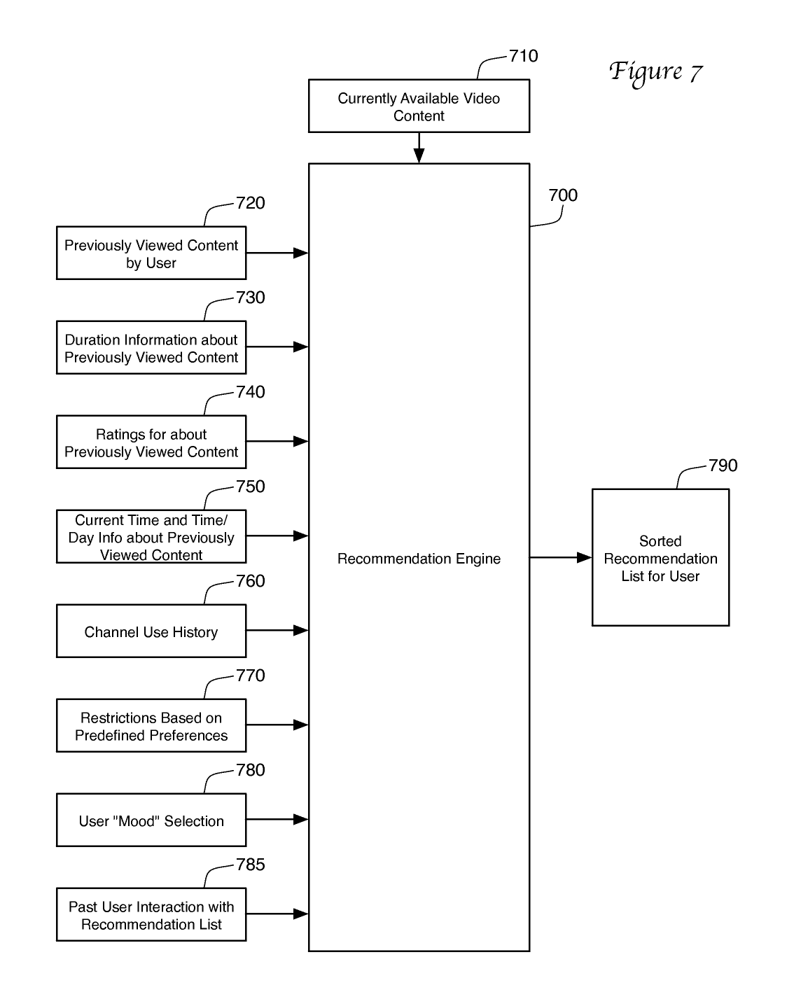

One possible method for implementing the My Program button 104 is shown in flowchart 600 shown in FIG. 6. The method begins with step 602 when the user presses the My Program button 104. Note that the nature of the present invention does not require that the method begin by pressing a physical button. For instance, instead of a physical button 104 specifically dedicated to this functionality, the user could press a virtual button on a touch screen, or could press a soft button that is labeled for this functionality at one time and has a different function at a second time. Alternatively, a user could implement a gesture in a gesture-based system, such as by dragging one or more fingers on a touch screen in a particular pattern. The process 600 could also be implemented through a natural user interface such as voice recognition or arm or body-motion gesture recognition implemented through a camera sensor. One advantage of most of these implementations of step 602 is that it requires only a single action interaction with the set-top box 130 or television 120 to switch to a recommended program. In prior art systems, a user must first navigate to a list of available or recommended programs, and then select a program off of this list. These prior art systems require multiple actions in the user interface, and therefore cannot present the immediacy of method 600.

The set-top box 130 or television 120 must respond to the single action identified in step 602 by presenting a best-guess recommended program to the user. To accomplish this, it is necessary to generate and rank recommended programs for the user so that the box 130 or television 120 can tune to the next recommended program. This can be accomplished live after the My Program button 104 is pressed, or the recommendations can be pre-generated before the button is pressed in step 602. The creation of a ranked program list is shown in steps 604-612 in FIG. 6 after the button press is received in step 602. This order is presented merely as an example, as it is contemplated and even intended that some or all of these steps will take place before the user presses the My Program button 104.

To generate the ordered list of recommended programs, the user is first identified at step 604. The identification of users might occur through one of the methods described above in association with FIGS. 5a-5g. Once identified, the history of viewing behavior for that user is retrieved from the database in step 606. Note that the identified user may include multiple individuals depending on the identification method utilized. As a result, the history received may include the history for both individuals separately as well as the history where both individuals were identified as present together.

In order to generate a ranked recommended list of programs for immediate viewing, the method 600 must determine at step 608 which programs are currently available. The set-top box 130 can determine which programming is currently available on a multi-channel video service from an electronic program guide. Such a guide will be available either from the cable or satellite service itself, or from a third party service provider such as Rovi Corporation of Santa Clara, Calif. In addition to programming on a multi-channel video service, video programming will also be available to users through other sources. For instance, the Hulu service streams a variety of television programs on demand to users over the Internet, while the Netflix streaming service allows users to select a movie or program for viewing from a catalog containing thousands of options. Other programs may be available for viewing that have been recorded on the device's DVR functionality. In addition, sports programming may be available from subscription Internet services such as those provided by Major League Baseball and the National Basketball Association. Such programming can be streamed live, or can be accessed after the event has taken place. Even rental movies that are streamed through fee-based rental websites such as CinemaNow (from Best Buy Co., Inc. of Richfield, Minn.) or Amazon Video on Demand (from Amazon.com, Inc. of Seattle, Wash.) may be considered as available.

Some available content will not change frequently. For instance, the content available over Internet streaming service might only change daily or weekly. In these cases, it will not be necessary for step 608 to reacquire content lists from these services if that content had been recently updated.

The currently available programming is then compared against the user's history in the database 200 via a recommendation engine in step 610 in order to generate a ranked list of available content. The recommendation engine can be selected from numerous available algorithms. Commercial engines can be obtained from Taboola.com Ltd (Tel-Aviv, Israel) or Jinni, Inc. (Yehud, Israel). Many other recommendation algorithms could also be used, including the algorithms that were submitted for the Netflix Prize competition for video recommendation engines. These include the “BellKor's Pragmatic Chaos” algorithm, which was the winning recommendation engine algorithm for the Netflix Prize.

FIG. 7 shows schematically the inputs considered by one embodiment of the recommendation engine 700 used by the present invention. The ratings engine 700 uses a plurality of inputs 720-785 to create a sorted recommendation list 790 chosen from the currently available video content 710. These inputs 720-785 include a listing of video programs previously viewed by currently identified user or users 720. In one embodiment, the recommendations can be based solely on this listing of previously viewed content 720. In this embodiment, it is not necessary for the user to rate any individual program. Instead, the mere fact that a user chose to watch a particular program is considered a positive rating by the recommendation engine. User preferences are determined by this viewing behavior, and the sorted recommendation list 790 can be created solely from this information.

One benefit of having the recommendation engine 700 receive a list of previously viewed content for a user 720 is that the engine 700 can avoid including previously watched programs in its recommendation list 790. If a user has recently watched a particular movie, the movie would be excluded from the list 790 for that user even it is highly ranked. Alternatively, if a user has watched episodes twenty-two to thirty-five of a television series on Hulu, these episodes can be removed from the recommendation list and the next episode (thirty-six) can be ranked highly in list 790.

In some embodiments, the recommendation engine 700 would rank programs solely on the habits of similar viewers using a collaborative filtering algorithm. In other cases, the recommendation engine 700 might dig more deeply into the data. Rather than recognizing that a viewer of “NBA Basketball” might prefer to watch another “NBA Basketball” program, the recommendation engine 700 might analyze the participants 224 of the sporting programs watched by the current users, and then recommend only basketball programs featuring a specific team (i.e., the Boston Celtics) or recommend sports programming only when it involves teams from a specific geographic location (i.e., Boston area teams).

In an alternative embodiment, the duration of time that the user has watched each program in their history can also be used as input 730 for the recommendation engine 700. A television program that is watch for ten minutes and is turned off before completion would be valued (or rated) lower than a program that is watched in its entirety. In another embodiment, the television 120, set-top box 130, or the remote 100 could include a rating mechanism to allow views to establish a rating for a video program currently being watched. The rating could be binary (thumbs up or down) or along a scale (1-4 or 1-10). The television 120 or set-top box 130 could periodically prompt for ratings in order to encourage the input of ratings by a user. These ratings 740 could then be included with the information input into the recommendation engine 700.

In addition, information about the time of day and day of week in which the previous content was viewed (item 750 in FIG. 7) can also be input into the recommendation engine 700. From this information, the recommendation engine can determine habits and preferences for various users. For instance, the recommendation engine 700 might determine that user “Sue” prefers to watch movies, particularly comedies, at 7 pm on certain nights of the week. As a result, the sorted recommendation list 790 for Sue might look different at 7 pm on those particular nights of the week than at other times. Alternatively, one user may historically only watch Football on Sunday afternoons. The recommendation engine 700 would therefore rank televised Football games highest during that time period, even if an otherwise more highly rated show for that user were currently being aired.

The recommendation engine 700 can also receive information about the particular channels viewed by a user 760. Using this information, the recommendation engine 700 can ascertain that a particular user watches numerous shows appearing on a particular channel from a multi-channel video programming service. For instance, user “Bob” may frequently watch shows from HGTV. This may indicate that Bob has a preference for that channel more so than a preference for any particular show on that channel. Other users may watch only a small subgroup of the available channels. A child, for instance, may restrict their viewing habits to six children's oriented television networks. With this information, the recommendation engine 700 can increase the ratings for programming shown on the preferred channels even if the programs would not otherwise rank highly.

In yet another embodiment, a user may establish particular preferences for themselves and their interaction with the television 120 or set-top box 130. As part of these preferences, the user may establish restrictions on the type of recommendations to be made by the recommendation engine 700. For instance, one user may prefer never to receive recommendations for content that must be streamed over the Internet. Another user may be a minor, for whom their parents have imposed rating restrictions that must be obeyed by the recommendation engine 700. A third user may wish for a particular channel to always be included in their recommendation list 790. This user may also include a preference ranks programs that are just beginning or about to begin much higher than programs that began more than 30 minutes in the past.

Another embodiment allows a user to input a preference for the type of programming they wish to see. For instance, a user may be in the mood for a comedy show, or sports programming, or a supernatural thriller. These categories can be selected through a user interface provided by the set-top box 130 through the remote 100 and the television 120. These moods can be implemented simply by allowing the user to select from pre-defined genres. Alternatively, the user can pre-define particular moods in their preferences. For instance, a user may wish to create an “After Bad Day at Work” mood that would emphasize the following types of programming: screwball comedies, special effects oriented sci-fi thrillers, and local sports programming. Once the preferences are established, it would be important to make the selection of the particular mood as easy as possible so that a user could quickly establish a mood either prior to pressing the My Program button 104, or as a replacement for that button. For instance, a user could have define multiple soft buttons on the remote, one for implementing a My Program process 600 for a first mood, and a second for implementing the process 600 for a second mood. Alternatively, each button could be a mood selection button, and the processes would still be instigated by pressing a single, dedicated My Program button.

Finally, it is possible for the recommendation engine 700 to consider past user behavior when interacting with the list of recommended programs 790. If the recommendation engine 700 consistently recommends programming stored by the user on a local hard drive, and the user has repeatedly rejected those suggestions, the recommendation engine 700 can use information about this behavior 785 to lower the ranking of such programming in the future.

Using some or all of these inputs 720-785, the recommendation engine 700 creates a list of recommended programming 790 chosen from the set of programming that is currently available to the user 710. This is shown as step 610 in the My Program process 600 shown in FIG. 6. In step 612, the recommendation engine 700 ranks this list to create a ranked list 790 to include a top choice, and a second choice, etc., that is custom tailored to the currently identified user.

The next step 614 in process 600 is to select the next programming content on the ranked list 790. The first time through the ranked list 790, this next content would be the highest ranked programming on the list 790. In one embodiment, the method 600 presents programming options to the user differently depending upon how long it takes to present that programming to the user. In flow chart 600, this distinction is simplified by determining whether the next available programming is available locally (i.e., through a cable or satellite provider), or is network-based content that is streamed over the Internet.

If the next content is considered local, the next programming choice for the user is immediately presented over the television 120 at step 618. To ensure that the user can quickly determine whether the presented programming is acceptable, the preferred embodiment also overlays on the screen a content label. This label should identify the content and the origin of this content. For instance, the content label might include the name of the television series, the episode title and number, the channel, the starting time for the episode, and the duration for a television show that is being shown on a multi-channel video service.

If the content is to be streamed over the Internet, it may take multiple seconds to connect to the Internet service and begin providing the content. Since one of the advantages of the My Program process is the experience of nearly instantaneous presentation to the user of the best programming immediately available to the user, the delay required before network based programming can be presented to the user might disrupt that experience. As a result, the embodiment shown in FIG. 6 presents a preview screen at step 620. The preview screen should present information about the selected next content to the user in a pleasing yet clear manner so that user can immediately determine which programming is presented. For instance, the preview screen could identify the name of a television show, the logo for that show, the episode number and title, a photograph showing actors of the show, a description of the episode, and the duration of that episode. The preview could also identify the source of the content (i.e., Internet streaming via the Hulu Plus service). If the user does not want to watch this programming, the user will press the My Program button 104 again to select the next content at step 622. This allows the user to identify and skip an Internet-based program even before any program content has been displayed to the user. The method 600 would then select the next content 614 from the sorted list 790 and repeat the presentation to the user.

Alternatively, the user may accept the content described in the preview screen at step 622. In one embodiment, acceptance occurs simply by doing nothing for a period of time. If the user accepts, step 624 will present the Internet content by loading the appropriate application with instructions to present the selected content on the television 120. To speed up this interaction, the loading of the appropriate application can occur in the background while the preview screen is presented. When the application is ready to present the program, the process 600 will remove the preview screen and present the appropriate content and the controlling application on the television 120. If the user chooses another program at step 622 before the application can show the content, the loading of the application will be canceled.

Instead of basing the distinction at step 616 on the location of the programming, the distinction could instead be based on actual access times. For instance, video content stored on an external hard drive could be included in the sorted recommendation list 790. However, accessing this content and changing the video source may take too long to present the proper experience to the user. As a result, such hard drive based content could be considered slow programming, with only cable or satellite programming being considered immediately available. Alternatively, the decision at step 616 could be skipped. In these embodiments, either all programming would be immediately loaded without a preview screen, or all programming would first be presented via a preview screen. The preview screen has some benefits even in the context of immediately available programming, as the user is immediately informed of all the relevant information for the immediately selected program in a consistent format. In a still further embodiment, the preview screen is partially transparent, allowing the preview screen to be presented while the user sees the presented content in the background.

Once the user has selected one of the presented programming choices, the method 600 simply waits for the next press of the My Programming button 104 at step 626. Once it is received, it is necessary to determine at step 628 if it is necessary to create a new recommendation list. The list will need to be recreated if the list 790 is stale, if the user has passed through the entire lists and wishes the list to be recreated, or if the user or users currently using the box 130 have changed. The list 790 will grow stale if sufficient time has passed such that the list of currently available video content 710 will have changed. Cable and satellite programming frequently changes on the half hour, so if the current time has passed a thirty minute period the list 790 will need to be refreshed. Alternatively, the identified user of the set-top box 130 might change, which could be self-reported by the user or detected by the box 130. Either way, a new recommendation list 790 will be needed, and the process 600 will return to step 604 (or step 608 if the identified user has not changed). If step 628 determines that the list 790 does not need to be updated, the press of button 104 will return the process to step 614.

The user may loop through all of the content on the recommendation list 790 by repeatedly pressing the My Programming button 104 at step 622 or step 628. In the preferred embodiment, the list 790 is of limited size (such as 4-10 programs). When the complete list 790 is presented, the process will circle back to the beginning. In this way, the user may review the entire list 790, and then select the best program on the second pass through the list 790.

After passing through the entire list, the user may be presented with an option to receive a new collection of programming options. If the user selects this option, the currently ranked list of programming 790 is scrapped, and a new list 790 is created containing a set of the next most highly ranked programs for that user.

In some embodiments, the pressing of the My Programming button at steps 622 or 628 soon after the method 600 presents the programming to the user indicates that the user has rejected that programming. In these embodiments, the method 600 will record the rejected programming so that it does not appear in future list of programming 790. This information is presented as input 785 to the recommendation engine 700. The engine 700 can be designed to completely avoid recommending programs that had been repeatedly skipped in process 600, or to simply reduce the ranking of such programs.

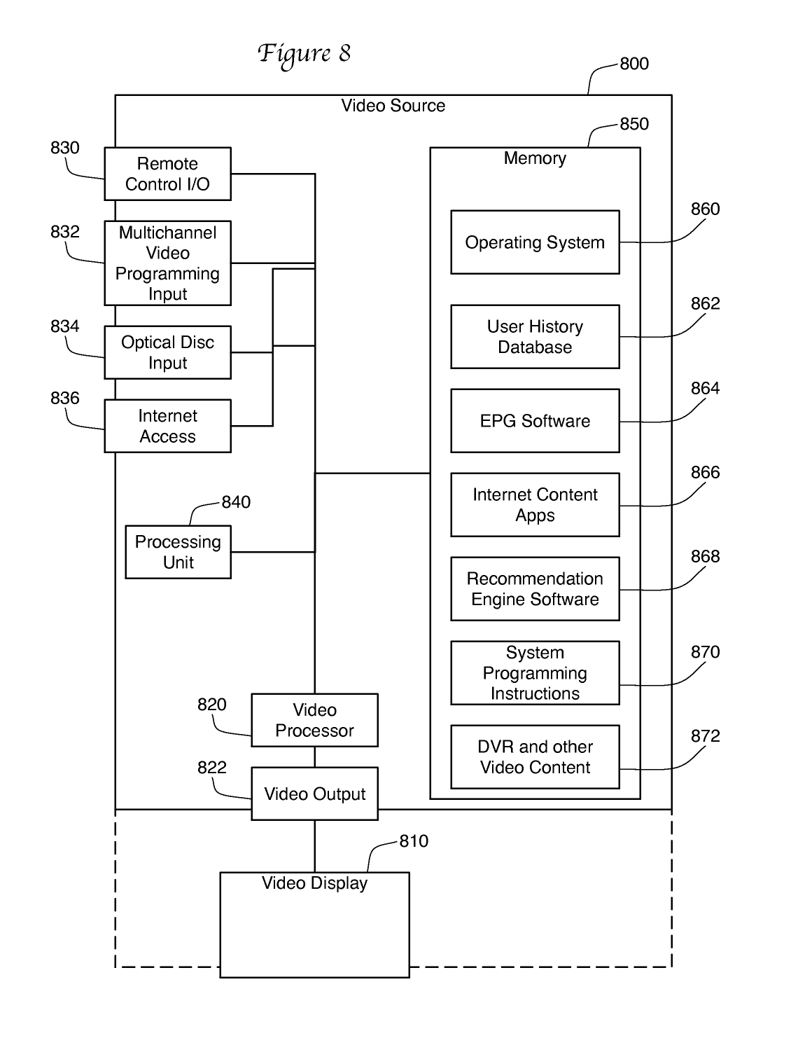

FIG. 8 shows a video source 800 that implements one embodiment of the present invention. The video source 800 could be a set-top box 130 or a television 120, or any other device that provides video programming for home video entertainment. The purpose of the video source 800 is to provide entertainment programming for video display 810. The video display 810 could form part of the video source device 800, as indicated by the striped outline 802 that incorporates the display 810 as part of the video source 800. Alternatively, the video display 810 could be separate from the rest of the video source 800, as would be the case with a set-top box 130 attached to a television 120. In this case, the video source would have a video processor 820 that feeds a video output port 822, which is then connected to an external video display 810.

In the preferred embodiment, the video source has a variety of input/output ports 830-836 in addition to the video output 822. The first port 830 receives commands from an external remote, such as remote 100. This port 830 preferable receives wireless communications from the remote, such as through an infrared or radio frequency receiver. It is also possible that this port 830 transmits signals to the remote for a two-way communication stream.

The second input port 832 receives input from a multichannel video programming service such as a satellite or cable television service. In the preferred embodiment, the video source 800 is able to directly access the various channels provided by the service. One way to access this service is through a CableCARD or AllVid device that forms part of port 832. In this way, the video source can change channels, access pay-per-view programming, and in some cases have direct access to information concerning the video being displayed on the service (such as through an electronic program guide). Port 834 is an optical disc device that reads and plays video stored on an optical disc, such as a DVD, Divx, or Blu-ray disc. In the preferred embodiment, the video source 800 has the ability to identify the content being played on the disc, such as through the VideoID database provided by Gracenote, Inc. Port 836 accesses a wide area network such as the Internet. The Internet access port 836 is used to receive video programming from services such as Hulu, Netflix, and CinemaNow.

Data received from the various ports 830-836 is analyzed and managed by a processing unit 840. In the preferred embodiment, this processing unit 840 is a general purpose CPU, such as a microprocessor produced by Intel Corp. (Santa Clara, Calif.) or Advanced Micro Devices, Inc. (Sunnyvale, Calif.). Although it is not a requirement of the present invention, one embodiment of this device 800 operates a general-purpose operating system 860 such as Linux (available through public distributions under the Gnu General Public License).

The operating system 860 is stored on a tangible, non-transitory memory device 850. In the preferred embodiment, the memory 850 is composed of multiple devices, including volatile RAM memory and non-volatile hard drive or flash based memory. In this embodiment, the operating system is permanently stored in non-volatile memory, and is loaded into volatile memory for faster access and performance when needed.

The memory 850 also contains the user history database 862, which consists of data of the type shown in FIG. 2 as well as programming instructions for storing, retrieving, and analyzing the data. Software 864 for analyzing and displaying electronic program guides is also found in memory 860, as are the software applications 866 that are needed to access and display Internet based video content such as Netflix and Hulu. These software applications 866 will include interfaces that allow the processing unit 840 to send commands to these applications 866 and receive back data about the video content provided by these services. The software 868 that implements the recommendation engine 700 is also stored on the memory 860. As described above, this software 868 is available from third parties who are skilled in the generation of video recommendation engines. Alternatively, the recommendation engine 700 can be accessed through the Internet access port 836, and the recommendation engine software 868 is responsible for interaction with the external engine, including the act of supplying the external engine with the appropriate data to generate the recommended programming list.

The memory 850 also contains the system software programming 870 that used by the processing unit 840 to integrate all the other software packages 860-868 used by the device 800. This software 870 operates the user interface presented on the video display 810, stores and retrieves data from the user history database, operates and extracts information from the EPG software 864 and the Internet Apps 866, and feeds data into the recommendation engine software 868. The sorted recommendation list received from the recommendation software is then used by the system programming 870 to implement the My Programming button functionality described above. The system programming instructions 870 can also store data in the memory 850 that is required for its operation. For instance, user preferences and data about separate users will be stored in the memory 850 by the system programming 870 during operation of these instructions 870.

Finally, the memory 850 can contain video content 872. This content 872 may include programs that are recorded from the multichannel video programming input 832, such as by implementing DVR functionality on the device 800. The user may also directly place the video content 872 into the memory 850 of the device 800. This content might include user generated content such as video from a video camera, or might include full length movies or television programs that have been converted into or downloaded in a format that can be stored on and retrieved off of a hard drive.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for recommending video programming to a user watching a television comprising:
a) identifying the user watching the television;
b) identifying currently viewed programming being watched by the user;
c) storing the identified programming along with a user identity associated with the user in a computerized database;
d) receiving a first input from the user indicating a desire to watch a highest-ranked video program, wherein the first input requires only a single action of the user;
e) identifying currently available programming for the television;
f) using a plurality of entries in the database for the user as input into a computerized video recommendation engine;
g) using the recommendation engine to generate a ranked list of recommended video programs for the user selected from the identified currently available programming; and
h) setting the television to display the highest-ranked video program on the ranked list of recommended video programs, wherein no additional action is required by the user beyond the single action of the user before the television displays the highest ranked program.

2. The method of claim 1, wherein the single action is pressing a single button on a remote control.

3. The method of claim 1, further comprising:
i) receiving a second input from the user after step h) indicating a desire to watch a next-highest-ranked video programming; and
j) setting the television to display the next-highest-ranked video program on the ranked list of recommended video programs.

4. The method of claim 3, wherein the second input from the user is the same single action of the user as the first input.

5. The method of claim 4, wherein the single action of the user is pressing a single button on a remote control.

6. The method of claim 5, wherein the single button is not used for any function other than to display a video program from the ranked list of recommended video programs.

7. The method of claim 4, wherein the currently viewed programming identified in step b) includes both programming from a multichannel video programming service and programming streamed over the Internet.

8. The method of claim 7, wherein the currently available programming for the television includes both programming from the multichannel video programming service and programming streamed over the Internet.

9. The method of claim 8, wherein the highest-ranked video program in step h) is programming on the multichannel video programming service and the next-highest-ranked video program on the ranked list of recommended video programs is programming streamed over the Internet.

10. The method of claim 8, wherein a preview screen is generated before displaying programming streamed over the Internet after the single action of the user.

11. The method of claim 10, wherein the preview screen includes an image relevant to the streamed programming and text describing the streamed programming.

12. The method of claim 4, wherein the user is identified in step a) through facial recognition.

13. The method of claim 4, wherein the process for identifying the user in step
a) is chosen from the set of processes comprising:
i) providing unique remote controls with unique identifiers for each of a plurality of users,
ii) providing a selectable physical switch on a remote control for user identification,
iii) providing a plurality of user buttons on the remote control with each button assigned to a particular user,
iv) requiring an input of a personal identifier using inputs found on the remote control,
v) using biometric identification means, and
vi) using voice recognition.

14. The method of claim 4, wherein the currently viewed programming identified in step b) includes programming from a multichannel video programming service, programming streamed over the Internet, and programming played from an optical disc.

15. The method of claim 1, wherein the single action of the user is making a physical gesture that is detected by a camera.

16. The method of claim 1, wherein the method is performed by a set-top box connected to the television.

17. The method of claim 1, wherein a plurality of users are identified, and further comprising storing preferences for the plurality of users, wherein the preferences alter the ranked list of recommended video programs generated by the recommendation engine.

18. An apparatus comprising:
a) a video processor;
b) a multichannel video programming input that receives multiple channels from an external programming service;
c) an Internet access port for receiving and transmitting data to a video streaming service;
d) a processing unit for processing data and instructions; and
e) a memory containing programming code instructions for the processing unit, the programming code instructions comprising
i) a user identification routine for identifying users of the apparatus,
ii) a programming identification routine for identifying programming received over both the Internet access port and the multichannel video programming input,
iii) a computerized history database associating identified users with identified programs watched by those users;
iv) a history database routine for storing information in the history database about programming identified by the programming identification routine that is being watched by users identified by the user identification routine,
v) a currently available program routine for identifying available programming over both the multichannel video programming input and the Internet access port,
vi) a video recommendation engine that ranks the available programming in a sorted recommendation list according at least in part to the history database, and
vii) a next-highest-ranked programming control routine that outputs programming from the sorted recommendation list through the video processor.

19. The apparatus of claim 18, wherein the next-highest-ranked programming control routine operates in response to a single action of a current user, wherein only the single action is required for the apparatus to change a current program being output by the video processor to the programming from the sorted recommendation list.

20. The apparatus of claim 19, wherein when the current program being output by the video processor was originally selected by the next-highest-ranked programming, then the next-highest-ranked programming selects the next-highest-ranked programming on the sorted recommendation list to be output by the video processor.

21. The apparatus of claim 20, wherein the video recommendation engine periodically recreates the sorted recommendation list, and further wherein the apparatus uses a clock to determine when the video recommendation engine should recreate the sorted recommendation list.

22. The apparatus of claim 21, wherein the apparatus causes the video recommendation engine to recreate the sorted recommendation list when the user identification routine detects a change in the users of the apparatus.

23. The apparatus of claim 18, wherein the programming identification routine further identifies programming received from an optical video disc.
